(19) United States
(12) Patent Application Publication
(10) Pub. No.: US 2023/0303799 A1
(43) Pub. Date: Sep. 28, 2023

(54) REMOVAL OF COLOR FROM POLYMERIC MATERIALS

(71) Applicant: ALADDIN MANUFACTURING CORPORATION, Calhoun, GA (US)

(72) Inventor: Anthony CASCIO, Calhoun, GA (US)

(21) Appl. No.: 18/020,286

(22) PCT Filed: Aug. 17, 2021
(86) PCT No.: PCT/US2021/046205

§ 371 Date: Feb. 8, 2023

Related U.S. Application Data
(60) Provisional application No. 63/066,408, filed on Aug. 17, 2020.

(51) Int. Cl. C08J 11/24; C08G 69/02

(52) U.S. Cl. CPC C08J 11/24; C08G 69/02; C08J 2377/06; C08J 2477/06

(57) ABSTRACT

The present disclosure is directed to methods for at least partially removing a dye from a dyed fiber comprising one or more polyamide or polyester polymers, and products formed thereof.

### CROSS-REFERENCE TO RELATED APPLICATIONS

This application claims the benefit of priority to U.S. Provisional Application No. 63/066,408, filed Aug. 17, 2020, the disclosure of which is incorporated herein by reference in its entirety.

### TECHNICAL FIELD

This disclosure relates to methods for recycling polymeric materials, and more particularly to method for removing one or more colorants from colored polyester or polyamide materials.

### BACKGROUND

Carpets make up a significant portion of the waste ending up in landfills, second only to diapers, with approximately 3.5 billion pounds entering each year into landfills in the United States. Corporate and business offices typically change their carpet every five to seven years, making handling of waste carpet an ongoing disposal challenge. Due to the complex makeup of carpets, including the colorants used to provide a color to the carpet, recycling is often a significant challenge.

Polyamides and polyesters are common polymer components used in the production of carpet fibers which find use in the production of other materials and thus would be valuable components to recycle. There is a clear need for methods that facilitate the recycling of polymer components from carpet or other polymeric materials, in particular methods that facilitate the removal of colorant components from said materials.

### SUMMARY

The present disclosure provides methods for the at least partial removal of one or more colorants from colored polymeric materials (for example, fibers) comprising polyester or polyamide polymers.

Thus in one aspect, a method is provided for at least partially removing one or more colorants from a colored polymeric materials, wherein the colored polymeric material comprises a polymer selected from one or more polyester polymers, one or more polyamide polymers, or mixtures thereof, the method comprising:
at least partially dissolving the colored polymeric material in a solvent to provide a mixture including a solubilized portion and optionally an insolubilized portion, wherein the solubilized portion includes therein at least a portion of the one or more colorants and the polymer;
optionally separating the solubilized portion from the insolubilized portion;
subjecting the solubilized portion to a separation technique to remove a majority of the one or more colorants from the solubilized portion to provide a solution comprising the polymer; and
precipitating the polymer from the solution.

In another aspect, a method is provided for at least partially removing one or more colorants from a colored polymeric material, wherein the colored polymeric material comprises a polymer selected from one or more polyester polymers, one or more polyamide polymers, or mixtures thereof, the method comprising:
at least partially dissolving the colored polymeric material in a solvent to provide a mixture including a solubilized portion and optionally an insolubilized portion, wherein the solubilized portion includes therein at least a portion of the polymer;
separating the solubilized portion from the insolubilized portion; and
precipitating the polymer from the solution.

In some embodiments, the solubilized portion includes at least a portion of the one or more colorants. In other embodiments, the solubilized portion does not include the one or more colorants, i.e., the one or more colorants are present in the insolubilized portion.

In some embodiments, the colored polymeric material comprises colored fibers. In some embodiments, the colored fibers are derived from waste fibers, for example fibers provided from a product such as carpets, rugs, mats, apparel fabric, drapery, upholstery, wall coverings, heavy industrial fabrics, ropes, cords, shoelaces, nettings, or the like.

In some embodiments, the waste fibers may comprise continuous filaments, monofilaments, or staple fibers.

In some embodiments, the polymer is selected from one or more polyester polymers, for example polyethylene terephthalate (PET), polybutylene terephthalate (PBT), polytrimethylene terephthalate (PTT), or combinations thereof.

In some embodiments, the polymer is selected from one or more polyamide polymers, for example polyamide 66, polyamide 6, polyamide 510, or polyamide 16.

In some embodiments, the one or more colorants comprise one or more dyes, one or more pigments, or combinations thereof.

In some embodiments, the solvent comprises an acidic solvent. In some embodiments, the acidic solvent comprises a solvent having a pKa ranging from 7 to 12 as measured in water at 25° C. In some embodiments, the acidic solvent may comprise a phenolic solvent, for example phenol, m-cresol, o-phenylphenol, p-phenylphenol, o-chlorophenol, trichlorophenol, or combinations thereof. In particular embodiments, the acidic solvent may comprise phenol or m-cresol.

In some embodiments, the solubilized portion is separated from the insolubilized portion. In some embodiments, separating the solubilized portion from the insolubilized portion comprises filtering the insolubilized portion away from the solubilized portion.

In some embodiments, the solubilized portion is subjected to a separation technique comprising chromatography, for example column chromatography, high performance liquid chromatography, or size-exclusion chromatography. In other embodiments, the separation technique comprises an electrochemical separation technique.

In some embodiments, precipitating the polymer from the solution comprises addition of an alcohol to the solution. In some embodiments, the alcohol may be selected from tert-amyl alcohol, benzyl alcohol, 1,4-butanediol, 1,2,4-butanetriol, butanol, 2-butanol, N-butanol, tert-butyl alcohol, di(propylene glycol) methyl ether, diethylene glycol, ethanol, ethylene glycol, 2-ethylhexanol, furfuryl alcohol, glycerol, isobutanol, isopropyl alcohol, methanol, 2-(2-methoxyethoxy)ethanol, 2-methyl-1-butanol, 2-methyl-1-pentanol, 3-methyl-2-butanol, neopentyl alcohol, 2-pentanol, 1,3-propanediol, 1-propanol, propylene glycol, propylene glycol methyl ether, or combinations thereof. In particular embodiments, the alcohol is isopropyl alcohol.

In some embodiments, the polymer may be isolated by filtration following precipitation from the solution.

In another aspect, a method is provided for preparing a recycled polyester or polyamide polymer product is provided using the methods described herein. In some embodiments, the recycled product may comprise a fiber, a pellet, a nurdle, or a flake.

In another aspect, a recycled polyester or polyamide polymer is provided prepared from a colored polymeric material by the methods described herein.

The details of one or more embodiments of the disclosure are set forth in the accompanying drawings and the description below. Other features, objects, and advantages of the disclosure will be apparent from the description and drawings, and from the claims.

### DETAILED DESCRIPTION

Before the present methods and systems are disclosed and described, it is to be understood that the methods and systems are not limited to specific synthetic methods, specific components, or to particular compositions. It is also understood that the terminology used herein is for the purpose of describing particular embodiments only and is not intended to be limiting.

As used in the specification and the appended claims, the singular forms “a”, “an” and “the” include plural referents unless the context clearly dictates otherwise.

“Optional” or “optionally” means that the subsequently described event or circumstance may or may not occur, and that the description includes instances where said event or circumstance occurs and instances where it does not.

The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments and are also disclosed.

“Exemplary means “an example of” and is not intended to convey an indication of a preferred or ideal embodiment.

It will be further understood that endpoints of each of the ranges provided are significant both in relation to the other endpoint, and independently of the other endpoint.

Other than in the examples, or where otherwise noted, all numbers expressing quantities of ingredients, reaction conditions, and so forth used in the specification and claims are to be understood at the very least, and not as an attempt to limit the application of the doctrine of equivalents to the scope of the claims, to be construed in light of the number of significant digits and ordinary rounding approaches.

“Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combination and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

Provided herein are methods for at least partially removing one or more colorants from colored polymeric materials composed of polyester or polyamide polymers that allows for the recycling of the polymer component to be used for other purposes. In some aspects, the present method comprises at least partially solubilizing the one or more colorants and the polyester or polyamide polymer components of the colored polymeric material while leaving other components behind as an insolubilized portion and then using a further separation technique, such as for example column chromatography, to separate the solubilized colorant and polymer components. In other aspects, the colorant and polymer are separated upon formation of a solubilized and insolubilized portion which are separated, i.e., the colorant is not found in the solubilized portion and remains in the insolubilized portion. In yet other aspects, the colorant and polymer components are separated upon precipitation of the polymer from the solution, with no further separation technique required to separate the colorant from the polymer.

In one aspect, the colored polymeric material is first dissolved in a solvent to provide an insolubilized portion and a solubilized portion. In some embodiments, the solubilized portion contains at least a portion of the one or more colorants and the polymer as originally found in the colored polymeric material, for example at least 50 wt.%, at least 60 wt.%, at least 70 wt.%, at least 80 wt.%, or more of the one or more colorants and the polymer is found in the solubilized portion, based upon the total weight of the one or more colorants and the polymer in the original colored polymeric material. In some embodiments, the solubilized portion only contains at least a portion of the polymer as originally found in the colored polymeric material. In such embodiments, the insolubilized portion may contain at least a portion (or in some further embodiments all) of the one or more colorants as found in the colored polymeric material. The insolubilized portion may further contain other components of the colored polymeric material than the polyester or polyamide polymer and/or colorant components, for example finish, paper, wire, or other forms of fibers such as cotton, rayon, wool, or acrylic fibers when the colored polymeric material comprises colored polymer fibers.

A polyester is defined as a synthetic linear polymer whose repeating contains contain ester functional groups, wherein these ester functional groups are integral members of the linear polymer chain.

Typical polyesters as used in the present disclosure were formed by condensation of a dicarboxylic acid and a diol. Representative examples of such dicarboxylic acids include terephthalic acid, isophthalic acid, 2,6-napthalene dicarboxylic acid, 3,4′-diphenylether dicarboxylic acid, hexahydrophthalic acid, 2,7-naphthalenedicarboxylic acid, phthalic acid, 4,4′-methylenebis(benzoic acid), oxalic acid, malonic acid, succinic acid, methyl succinic acid, glutaric acid, adipic acid, 3-methyladipic acid, pimelic acid, suberic acid, azelaic acid, sebacic acid, 1,11-undecanedicarboxylic acid, 1,10-dodecanedicarboxylic acid, undecanedioic acid, 1,12-dodecanedicarboxylic acid, hexadecanedioic acid, docosanedioic acid, tetracosanedioic acid, 1,4-cyclohexanedicarboxylic acid, 1,3-cyclohexanedicarboxylic acid, 1,2-cyclohexanediacetic acid, fumaric acid, and maleic acid. Representative examples of such diols include monoethylene glycol, diethylene glycol, triethylene glycol, poly(ethylene ether)glycols, 1,3-propanediol, 1,4-butanediol, poly(butylene ether)glycols, pentamethylene glycol, 1,6-hexanediol, 1,8-octanediol, 1,10-decanediol, 1,12-dodecanediol, 1,14-tetradecanediol, 1,16-hexadecanediol, cis-1,4-cyclohexanedimethanol, and trans-1,4-cyclohexanedimethanol.

Representative examples of polyesters as may be used in the present disclosure include poly(ethylene terephthalate) (PET), poly(trimethylene terephthalate) (PTT), poly(butylene terephthalate) (PBT), poly(ethylene isophthalate), poly(octamethylene terephthalate), poly(decamethylene terephthalate), poly(pentamethylene isophthalate), poly(butylene isophthalate), poly(hexamethylene isophthalate), poly(hexamethylene adipate), poly(pentamethylene adipate), poly(pentamethylene sebacate), poly(hexamethylene sebacate), poly(1,4-cyclohexylene terephthalate), poly(1,4-cyclohexylene sebacate), poly(ethylene terephthalate-co-sebacate), and poly(ethylene-co-tetramethylene terephalate).

A polyamide is defined as a synthetic linear polymer whose repeating contains contain amide functional groups, wherein these amide functional groups are integral members of the linear polymer chain. The polyamide as found in the present disclosure may have been formed by any number of methods known in the art.

In some embodiments, the polyamide may have been formed by condensation polymerization of a dicarboxylic acid and a diamine. Representative examples of such dicarboxylic acids include terephthalic acid, isophthalic acid, 2,6-napthalene dicarboxylic acid, 3,4′-diphenylether dicarboxylic acid, hexahydrophthalic acid, 2,7-naphthalenedicarboxylic acid, phthalic acid, 4,4′-methylenebis(benzoic acid), oxalic acid, malonic acid, succinic acid, methyl succinic acid, glutaric acid, adipic acid, 3-methyladipic acid, pimelic acid, suberic acid, azelaic acid, sebacic acid, 1,11-undecanedicarboxylic acid, 1,10-dodecanedicarboxylic acid, undecanedioic acid, 1,12-dodecanedicarboxylic acid, hexadecanedioic acid, docosanedioic acid, tetracosanedioic acid, 1,4-cyclohexanedicarboxylic acid, 1,3-cyclohexanedicarboxylic acid, 1,2-cyclohexanediacetic acid, fumaric acid, and maleic acid. Representative examples of such diamine include ethylene diamine, tetramethylene diamine, hexamethylene diamine, 1,9-nonanediamine, 2-methyl pentamethylene diamine, trimethyl hexaminethylene diamine (TMD), m-xylylene diamine (MXD), and 1,5-pentanediamine.

In some embodiments, the polyamide may have been formed by condensation polymerization of an amino acid (such as 11-aminoundecanoic acid) or ring-opening polymerization of a lactam (such as caprolactam or ω-aminolauric acid).

Representative examples of polyamides as may be used in the present disclosure include: aliphatic polyamides such as polyamide 6, polyamide 11, polyamide 12, polyamide 46, polyamide 410, polyamide 4T, polyamide 510, polyamide D6, polyamide DT, polyamide DI, polyamide 66, polyamide 610, polyamide 612, polyamide 6T, polyamide 6I, polyamide MXD6, polyamide 9T, polyamide 1010, polyamide 10T, polyamide 1212, polyamide 12T, polyamide PACM12, polyamide TMDT, polyamide 611, and polyamide 1012; polyphthalimides such as polyamide 6T/66, polyamide LT/DT, and polyamide L6T/6I; and aramid polymers.

In some embodiments, the solvent may comprise an acidic solvent. In typical embodiments, the acidic solvent comprises a solvent having a pKa from 7 to 12 when measured in water at 25° C. In some embodiments, the acidic solvent comprises a phenolic solvent. Representative examples include, but are not limited to, phenol, m-cresol, o-phenylphenol, p-phenylphenol, o-chlorophenol, trichlorophenol, 2,6-xylenol, or combinations thereof.

In some embodiments, one or more additional solvents may be combined with the acidic solvent. Such solvents may include, but are not limited to, p-chloroanisole, nitrobenzene, acetophenone, propylene carbonate, dimethyl sulfoxide, quinoline, trifluoroacetic acid, trichloroethane, trichloroacetic acid, water, 1,1,2,2-tetrachloroethane, 1,1,2-trichloro-1,2,2-trifluoroethane, and 1,1,1,3,3,3-hexafluoroisopropanol. Other solvents that may be combined with the acidic solvent may include diphenyl, diphenyl ether, naphthalene, methylnaphthalene, benzophenone, diphenylmethane, para-dichlorobenzene, acenaphthene, and phenanthrene.

The insolubilized portion and the solubilized portion may then be separated. The insolubilized portion and the solubilized portion may be separated by any suitable separation technique, for example such as screening, decanting, filtration, centrifugation, or trituration of the solubilized portion away from the insolubilized portion, or by using a combination of such procedures. In some embodiments, the solubilized portion and the insolubilized portion may be separated by chromatography or electrophoresis. In some embodiments, for example when the insolubilized portion comprises one or more magnetic materials such as iron containing particles, the insolubilized portion may be separated from the solubilized portion by the application of a magnetic field.

In some embodiments, the one or more colorants and the polymer in the solubilized portion may be subsequently separation using a separation technique, for example using a type of chromatography. Chromatography typically comprises dissolving a mixture in a fluid called the mobile phase and carrying it through a structure holding another material called the stationary phase. The one or more colorants and polymer travel at different speeds due to differential partitioning between the mobile and stationary phases, causing them to separate. Subtle differences in the partition coefficient of the colorant and polymer components results in differential retention in the stationary phase and thus affect the separation.

In some embodiments, the chromatography technique comprises column chromatography, i.e. where the stationary bed is within a tube. The particles of the solid stationary phase or the support coated with a liquid stationary phase may fill the whole inside volume of the tube (packed column) or be concentrated on or along the inside tube wall leaving an open, unrestricted path for the mobile phase in the middle part of the tube (i.e., a open tubular column). This technique can be used on scales from micrograms up to kilograms. The main advantage of column chromatography is the relatively low cost and disposability of the stationary phase used in the process, prevention cross-contamination or stationary phase degradation due to recycling. Column chromatography can be done using gravity to move the mobile phase or a compressed gas to push the solvent through the column. A column is typically prepared by packing a solid adsorbent into a cylindrical glass or plastic tube. The size of the column used will be dependent upon the amount of polymer to be isolated. The stationary phase or adsorbent is a solid. The most common stationary phases for column chromatography are silica gel and alumina, but a wide range are available to perform ion exchange chromatography, reversed-phase chromatography, affinity chromatography, or expanded bed adsorption. An appropriate stationary phase would be readily chosen by a person of skill in the art based upon the dye and polymer components to be separated. In other embodiments, the chromatography technique may comprise planar chromatography, i.e. where the stationary phase is present as or on a plane. In some embodiments, the chromatography technique may comprise high performance liquid chromatography.

The mobile phase as used in the chromatographic techniques described herein is typically a liquid. The mobile phase may comprise the solvent used to form the solubilized and insolubilized portion (for example, an acidic solvent), a mixture of said solvent and one or more additional solvents, or one or more other solvents that solubilize the colorant and polymer components. The one or more solvents used for the chromatographic separation will be dependent upon the specific chromatographic technique used as well as the particular colorant and polymer to be separated and may be readily determined by a person of skill in the art. In typical embodiments, the stationary phase is more polar than the mobile phase (i.e., normal phase liquid chromatography), but may be the opposite (i.e., reversed-phase liquid chromatography) depending upon the particular compositions intended for separation.

In some embodiments, the chromatographic separation technique comprises size-exclusion chromatography. Size-exclusion chromatography, also known as gel permeation chromatography or gel filtration chromatography, separates molecules according to their size and in some cases molecular weight. The chromatography column is typically packed with fine porous beads which are composed of dextran polymers, agarose, or polyacrylamide.

In some embodiments, the separation technique comprises an electrochemical separation technique. A representative, non-limiting example of such a technique comprises contacting the solubilized portion with a chelating agent (for example ethylenediamine tetra acetic acid or EDTA) which is capable of binding to divalent metal components of some colorants. The solubilized portion may then be subjected to electrical currents which help facilitate the separation of the colorant components from the polymer.

Upon obtaining the solution comprising the polyester or polyamide polymer, the polymer is precipitated from the solution. Upon precipitation, the polymer may further be isolated by filtration or centrifugation away from the resulting supernate. In some embodiments, an alcohol is added to the solution to precipitate the polyester or polyamide polymer. Representative examples of alcohols which may be used include, but are not limited to, tert-amyl alcohol, benzyl alcohol, 1,4-butanediol, 1,2,4-butanetriol, butanol, 2-butanol, n-butanol, tert-butyl alcohol, di(propylene glycol) methyl ether, diethylene glycol, ethanol, ethylene glycol, 2-ethylhexanol, furfuryl alcohol, glycerol, isobutanol, isopropyl alcohol, methanol, 2-(2-methoxyethoxy)ethanol, 2-methyl-1-butanol, 2-methyl-1-pentanol, 3-methyl-2-butanol, neopentyl alcohol, 2-pentanol, 1,3-propanediol, 1-propanol, propylene glycol, propylene glycol methyl ether, or combinations thereof. In particular embodiments, the alcohol includes isopropyl alcohol.

In some embodiments, the alcohol may be combined with one or more additional solvents. Such solvents may include, but are not limited to, acetone, benzene, 2-butanone, dichloromethane, dimethylacetamide, dimethylformamide, hexane, N-methyl-2-pyrrolidone, tetrachloromethane, toluene, 1,1,1-trichloroethane, water, and xylene.

Following precipitation and subsequent separation from the supernate, the separated polymer may be subjected to any additional purification techniques (for example, distillation) necessary to provide the desired level of purity for its intended application or purpose. The recycle polymer may then be used to form a recycled polymer product, for example a fiber, a pellet, a nurdle, or a flake.

### EXAMPLES

By way of non-limiting illustration, examples of certain embodiments of the present disclosure are given below.

### Example 1. Recycling of Polyethylene Terephthalate Polymer from Waste Carpet

Waste PET carpet is shredded and then introduced into phenol at 30:1 ratio of solvent to waste carpet. The material is mixed with the solvent for 30 to 60 minutes at 70° C. to form solubilized and insolubilized portions. The mixture is then passed through a 5 micron filter to separate the solubilized and insolubilized portions. Isopropanol is then added to the filtrate to precipitate the PET polymer from the solution. The precipitate is then filtered, and the solid PET is rinsed with isopropanol. The material is then collected and may be used in further processing.

### Example 2. Recycling of Nylon Polymer from Waste Carpet

Waste nylon carpet is brought up in a 25:1 mixture of phenol/methanol The material is mixed with the solvent for 60 minutes at 70° C. to form solubilized and insolubilized portions. The material is then filtered using a 5 micron filter to separate the two portions. The insolubilized portion may be neutralized with isopropanol and water and then collected. The remaining material is a combination of calcium carbonate, latex, and polypropylene which can be further separated as needed. The filtrate is then passed through a chromatography column containing 0.075-0.25 mm silica with 150 angstrom porosity to separate the dye from the polymer. Isopropanol is then introduced to the resulting solution to precipitate the nylon polymer.

### Example 3. Recycle of Polyester Polymer from Waste Carpet

Waste polyester carpet is brought up in a 30:1 mixture of phenol/methanol. The material is mixed with the solvent for 60 minutes at 70° C. to form solubilized and insolubilized portions. The material is then filtered using a 10 micron filter to filter away larger insolubilized material. The filtrate is then passed again through a 0.5 micron filter to further separate the solubilized and insolubilized portions. The insolubilized portions may be neutralized with isopropanol and water and then collected. The remaining material is a combination of calcium carbonate, latex, colorants, additives, and polypropylene which can be further separated as needed. The filtrate is then passed through a chromatography column containing 0.075-0.25 mm silica with 150 angstrom porosity to separate any remaining dye components from the polymer. Isopropanol is then introduced to the resulting solution to precipitate the polyester polymer.

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein; however, other combinations of steps, elements, components, and constituents are included, even though not explicitly stated.

What is claimed is:

1. A method for at least partially removing one or more colorants from a colored polymeric material, wherein the colored polymeric material comprises a polymer selected from one or more polyester polymers, one or more polyamide polymers, or mixtures thereof, the method comprising:
at least partially dissolving the colored polymeric material in a phenolic solvent to provide a mixture comprising a solubilized portion and an insolubilized portion, wherein the solubilized portion comprises at least a portion of the one or more colorants and the polymer;
subjecting the solubilized portion to a separation technique to remove a majority of the one or more colorants from the solubilized portion to provide a solution comprising the polymer; and
precipitating the polymer from the solution.

2-13. (canceled)

14. The method of claim 1, wherein the phenolic solvent comprises an acidic solvent having a pKa ranging from 7 to 12 as measured in water at 25° C.

15. (canceled)

16. The method of claim 1, wherein the phenolic solvent comprises phenol, m-cresol, o-phenylphenol, p-phenylphenol, o-chlorophenol, or trichlorophenol.

17-20. (canceled)

21. The method of claim 1, wherein separating the solubilized portion from the insolubilized portion comprises filtering the insolubilized portion away from the solubilized portion.

22-26. (canceled)

27. The method of claim 1, wherein precipitating the polymer from the solution comprises the addition of an alcohol to the solution.

28. The method of claim 27, wherein the alcohol is selected from the group consisting of tert-amyl alcohol, benzyl alcohol, 1,4-butanediol, 1,2,4-butanetriol, butanol, 2-butanol, N-butanol, tert-butyl alcohol, di(propylene glycol) methyl ether, diethylene glycol, ethanol, ethylene glycol, 2-ethylhexanol, furfuryl alcohol, glycerol, isobutanol, isopropyl alcohol, methanol, 2-(2-methoxyethoxy)ethanol, 2-methyl-1-butanol, 2-methyl-1-pentanol, 3-methyl-2-butanol, neopentyl alcohol, 2-pentanol, 1,3-propanediol, 1-propanol, propylene glycol, propylene glycol methyl ether, or combinations thereof.

29. The method of claim 27, wherein the alcohol comprises isopropanol.

30. The method of claim 27, wherein the polymer is isolated by filtration following precipitation from the solution.

31-41. (canceled)

42. The method of claim 1, wherein the one or more polyester polymers comprises polyethylene terephthalate (PET), polybutylene terephthalate (PBT), polytrimethylene terephthalate (PTT), or combinations thereof.

43. (canceled)

44. The method of claim 1, wherein one or more polyamide polymers comprise polyamide 66, polyamide 6, polyamide 510, polyamide 16, or combinations thereof.

45-60. (canceled)
